(19) United States
(12) Patent Application Publication
(10) Pub. No.: US 2026/0293807 A1
(43) Pub. Date: Oct. 1, 2026

(54) FOLDING PICK-UP ATTACHMENT FOR A HARVESTING MACHINE

(71) Applicant: Carl Geringhoff GmbH & Co. KG, Ahlen (DE)

(72) Inventors: André HEMMESMANN, Sassenberg (DE); Holger STRUNK, Wadersloh (DE); Cristiano SCHWARTZ, Ahlen (DE); Reimer Uwe TIESSEN, Oldenburg (DE); Andreas LEUDERALBERT-BOWE, Gronau (DE)

(73) Assignee: Carl Geringhoff GmbH & Co. KG, Ahlen (DE)

(21) Appl. No.: 19/475,800

(22) PCT Filed: Apr. 15, 2024
(86) PCT No.: PCT/DE2024/100315

§ 371 Date: Oct. 16, 2025

(30) Foreign Application Priority Data
May 4, 2023 (DE) 10 2023 111 687.8

(51) Int. Cl. A01D 41/14; A01B 73/04; A01D 41/10; A01D 61/00; A01D 89/00

(52) U.S. Cl. CPC A01D 41/144; A01B 73/044; A01D 41/10; A01D 61/004; A01D 89/004

(57) ABSTRACT

A folding pick-up attachment for a harvesting machine, preferably for a forage harvester, has a receiving rotor and a feed screw, that is subdivided into two feed screw parts. The feed screw is mounted on the machine frame in a pendular manner, so that the feed screw can be adjusted to different layer thicknesses of the harvested crop. Because, in the transport position, the foldable machine frame part is transferred vertically through 180° over the unfolded machine frame, it is necessary to reversibly fix the pendular-mounted feed screw part with respect to the machine frame part, in order to prevent pivoting during the transfer from the working position into the transport position. A corresponding device for this purpose ensures that the feed screw is fixed.

The invention relates to a foldable pick-up attachment for a harvesting machine, preferably for a forage harvester, in particular for a self-propelled forage harvester, which has a pick-up rotor with pick-up tools for picking up crop from the ground and an intake auger for uniformly forwarding or handing off the picked-up crop to the harvesting machine.

Forage harvesters are harvesting machines that are used to harvest and collect crop, cut harvested crop to short parallel lengths, and convey the chopped material into containers or separate vehicles. Typical harvested crops are grasses, stalk-like crops, such as alfalfa or field grass, legumes, mixtures and/or row crops, such as corn or millet. The chopped material can either be fed directly to the livestock as feed or stored by silage or drying in order to feed this to the livestock later as feed. The forage harvester can harvest the crop directly by cutting in full width, or from individual rows or multiple rows, or by picking up from the swath. Forage harvesters can be mounted on the tractor, drawn by a tractor, or self-propelled.

A front harvesting attachment is a typically removable device for feeding the harvested crop into the harvesting machine, in particular into the forage harvester. A front harvesting attachment in the form of a pick-up attachment is specifically a device for picking up previously cut crop. The crop can be set down in rows or swaths.

Self-propelled forage harvesters have now reached an engine power of over 1000 HP. In parallel with the engine power, the throughput capacity of forage harvesters has also increased. In addition to the high engine power and throughput capacity necessary for corn silage, the harvesting capacity is also an important factor for high feed quality in grass silage. After mowing, the meadows and fields must be cleared within a short time window in order to be able to silage, for example, the green crop with an optimal content of dry substance.

In order to be able to take full advantage of the high throughput capacity of a harvesting machine, in particular of a forage harvester, it is inter alia necessary to considerably increase the ground speed of the harvesting machine.

The increase in the working speed, or the ground speed, of the harvesting machine, in particular of the forage harvester, as an increase in harvesting capacity that is quasi neutral with regard to investment, is associated with negative side effects, which are described in greater detail in the following.

It is known that harvesting machines, for example, forage harvesters, usually have a ground pressure controller and a lateral tilt frame for the height guidance or adaptation to ground contours by the pick-up attachment. A ground pressure controller responds sluggishly, however, such that this can no longer operate effectively and responsively at higher ground speeds. As a consequence thereof, the pick-up attachment poorly adapts to ground contours, which in turn results in crop losses, excessive contamination of feed, and increased machine wear, as explained in greater detail in the following.

If the harvesting machine, in particular the forage harvester, travels at a high ground speed over a summit, the ground pressure controller cannot lower the pick-up attachment and, thus, the pick-up rotor, in a timely manner, such that this is guided too high for a certain time and distance, wherein the pick-up tools, in particular rake tines, of the pick-up rotor no longer extend to the topsoil, which results in crop losses, since crop material is not collected. The result, therefore, is crop losses that remain on the field, since the optimal rake height could not be maintained.

If the harvesting machine, in particular the forage harvester, travels at an increased ground speed through a depression, the ground pressure controller cannot raise the pick-up attachment and, thus, the pick-up rotor, in a timely manner, such that this is guided too low for a certain time and distance. As a result, the pick-up tools, in particular rake tines, of the pick-up rotor aggressively comb through the ground, or through the topsoil, which results in excessive contamination of the harvested crop and, thus, contamination of the feed and, therefore, a reduction in feed quality, damage to the topsoil, and increased wear both on the pick-up attachment and on the harvesting machine, for example, on the forage harvester, since a large amount of filth, in particular sand and ground, is also picked up. Breakage of the pick-up tools, in particular of the rake tines, is also possible.

The drivers of forage harvesters and transfer vehicles require a considerably higher degree of concentration at higher ground speeds, and therefore exhaustion is reached much sooner. As a result, changes in the contour of the ground caused, for example, by ditches, i.e., by narrow trenches between individual fields used for water drainage, by wet areas, or by other obstacles, are detected late, as a result of which it becomes difficult to manually adapt the ground speed and the height of the pick-up attachment in a timely manner.

For the aforementioned reasons, it makes sense to increase the working width of the pick-up attachment in order to be able to pick up that much more crop, or crop mass, or crop material, during a pass. The ground speed can, as a result, be held at a lower level, which in turn relieves the driver, increases the feed quality, and prevents increased machine wear and, in addition, is also more fuel-efficient.

The harvesting capacity is an important factor for high feed quality and productivity, in particular in grass silage. After mowing, the meadows and fields must be cleared within a short time window, as described above, in order to be able to silage, for example, the green crop with an optimal content of dry substance. The driver of the harvesting machine in the harvesting chain is therefore under high time pressure. In addition, in particular during grass harvesting, the areas to be harvested are frequently changed due to the high harvesting capacity, such that no time remains to set up or change over the pick-up attachment between transport on the road and field work. For this reason, wider rigid pick-up attachments are not expedient, since these must be detached from the harvesting machine, in particular the forage harvester, and loaded onto a trailer to be transferred between the different areas. The trailer is then coupled to the harvesting machine, in particular the forage harvester, and drawn to the nearest plot, wherein in turn the pick-up attachment must be mounted on the harvesting machine, in particular the forage harvester, and set up for use in the field. This method is very time-consuming and impractical.

The better alternative is the use of foldable pick-up attachments.

Foldable pick-up attachments are known in connection with self-propelled forage harvesters, for example with corn headers, which are used during harvesting corn for silage. Moreover, foldable pick-up attachments are known in connection with self-propelled combine harvesters, for example with corn pickers or grain headers, which are used to harvest grain corn or grain.

The set-up times for foldable pick-up attachments are advantageously significantly lower than those for rigid, i.e., non-foldable pick-up attachments, which must be set down onto a trailer for transport on the road and drawn with the harvesting machine, for example, the forage harvester, to the nearest field. The driver can swivel the foldable pick-up attachment, advantageously from the cab or the operator's platform, hydraulically and/or electrically reversibly between a working position and a transport position. In many cases, it is therefore no longer necessary to leave the cab or climb down from the operator's platform. For foldable pick-up attachments, the average set-up time for changing between the two operating states, i.e., the working position and the transport position, or vice versa, is considerably less than one minute.

Foldable pick-up attachments are known which have machine frames formed in two parts or three parts. In a two-part machine frame, the one machine half folds through 180° over the other. In a three-part machine frame, the two outer machine parts each fold through 180° over the middle machine part. Intake augers are installed in both variants, which are arranged either rigidly or in a minimally swinging manner. In the rigid variant, although the position of the intake auger relative to the machine frame is adjustable, it is fixed in the adjusted position.

It is important primarily during chopping and picking up stalk-like crops, in particular grass, that the mechanisms of the pick-up attachment for picking up, conveying, and guiding the crop can adapt to the layer thickness of the crop stream without excessively accumulating and/or decelerating the crop. If the intake auger is suspended on the machine frame of the pick-up attachment rigidly or with only a very slight swinging motion, the intake auger cannot adapt to the strongly fluctuating layer thicknesses of the crop mat. This results in an uneven loading of the harvesting machine, in particular of the forage harvester, which in turn negatively affects the chopping quality and the feed quality and reduces the productivity and the fuel efficiency. Moreover, due to the poor flow of harvested crop, higher losses of crop and broken crop set in with very dry and/or leafy crops, for example, lucerne, or alfalfa.

In grass silage, an interruption of the flow of harvested crop or an emergency stop of all intake conveyor mechanisms is also not unusual, in particular when the intake conveyor mechanisms of the harvesting machine, in particular of the forage harvester, detect foreign objects, for example, metal parts or stones. Such foreign objects can severely damage the harvesting machine, in particular the forage harvester, such that lengthy and expensive repairs are necessary. During an emergency stop of the intake conveyor mechanisms and, thus, of the pick-up attachment during the harvesting operation, large residual quantities of crop contaminated with these foreign objects remain in the pick-up attachment and ahead of the pre-compression housing of the harvesting machine, in particular of the forage harvester. These residual quantities must be removed and investigated for foreign objects. Since the intake auger of the pick-up attachment is arranged directly ahead of the pre-compression housing of the harvesting machine, in particular of the forage harvester, this must be moved for cleaning and to search for foreign objects. Only then is better access achieved into the pick-up attachment and to the compression rollers of the harvesting machine, in particular of the forage harvester. In the known foldable pick-up attachments with a rigidly installed intake auger or with intake augers having very slight swinging motion, it is not readily possible to move the intake auger. As a result, it becomes very difficult for the driver to clean and/or clear out the pick-up attachment after an emergency stop or any other type of irregularity in the flow of harvested crop.

Proceeding from this prior art, the problem addressed by the invention is that of improving a foldable pick-up attachment for a harvesting machine, in particular for a forage harvester, preferably for a self-propelled forage harvester.

This problem is solved in the case of a foldable pick-up attachment for a harvesting machine, in particular for a preferably self-propelled forage harvester, by the features of Claim 1. Developments and advantageous embodiments of the invention can be gathered from the dependent claims.

The foldable pick-up attachment according to the invention for a harvesting machine, preferably for a forage harvester, particularly preferably for a self-propelled forage harvester, comprises a pick-up rotor with pick-up tools for picking up crop from the ground and an intake auger for uniformly forwarding or handing off the picked-up crop to the harvesting machine, in to the forage harvester, wherein the pick-up attachment has a machine frame, which is foldable apart into a working position and foldable together into a transport position using a folding mechanism, wherein the machine frame has a folding machine frame part. The intake auger is suspended according to the invention on the machine frame in a swinging manner such that this is adaptable to different layer thicknesses of the picked-up crop by lifting and lowering. At least one device can be provided according to the invention, by means of which at least that part of the intake auger that is suspended on the folding machine frame part is reversibly fixable, as necessary, relative to or on this machine frame part.

The pick-up attachment according to the invention for a harvesting machine, in particular for a forage harvester, is based on the concept addressed by the invention that, for example, in addition to the pick-up rotor and a hold-down unit, the intake auger is also suspended on the machine frame of the pick-up attachment in a swinging manner. The swinging suspension makes it possible for the intake auger to be lifted, in particular deflected, upwards and for the intake auger to be lowered downwards. If the layer thickness of the crop mat increases, the intake auger can, according to the invention, deflect upwards. If the layer thickness of the crop mat decreases, the intake auger can, according to the invention, lower accordingly. As a result, an optimal pick-up, compression, and conveying capacity of the intake auger is achieved with simultaneously low crop losses. The maximum swing travel is specifiable.

The pick-up attachment according to the invention ensures an optimal flow of harvested crop, which in turn positively affects the chopping quality and the feed quality and increases the productivity and the fuel efficiency. Moreover, due to the optimized flow of harvested crop, the losses of crop and broken crop with very dry and/or leafy crops, such as lucerne or alfalfa, are reduced.

In addition, the swinging connection of the intake auger to the machine frame according to the invention is an important factor for the accessibility into the interior of the pick-up attachment, or to the intake mechanisms of the harvesting machine, in particular of the forage harvester. It is not unusual in grass silage, as described above, for the flow of harvested crop to be interrupted or for all intake conveyor mechanisms to be stopped, for example, when the intake conveyor mechanisms of the harvesting machine, in particular of the forage harvester, detect foreign objects, for example, metal parts or stones. Foreign objects, in particular metal parts or stones, can severely damage the harvesting machine, in particular the forage harvester, such that lengthy and expensive repairs are necessary. During an emergency stop of the intake conveyor mechanisms and, thus, of the pick-up attachment, during the harvesting operation, large residual quantities of contaminated crop remain in the pick-up attachment and ahead of the pre-compression housing of the harvesting machine, in particular of the forage harvester. These residual quantities must be removed and investigated for foreign objects. Since the intake auger of the pick-up attachment is arranged directly ahead of the pre-compression housing of the harvesting machine, in particular of the forage harvester, this can be moved into and secured in an upper position of its swinging range by lowering or raising according to the invention for the purpose of cleaning and searching for foreign objects. This offers the operator, for example, the driver of the harvesting machine, good access into the pick-up attachment and to the compression rollers of the harvesting machine, in particular of the forage harvester.

The disadvantage of the assemblies arranged in a movable or swinging manner, in particular of the intake auger parts suspended in a swinging manner according to the invention, in the case of foldable pick-up attachments, the machine parts of which are folded between a transport position and a working position, or vice versa, is that the intake auger parts suspended so as to be movable or swinging relative to the folding machine frame parts inadvertently drop from one end position into another end position when the machine parts are transferred from a working position into a transport position, or vice versa. This is due to the fact that the folding machine frame parts are folded through more than 90°, usually even 180°, toward the plane of the ground. Once the folding machine frame parts of the pick-up attachment have been transferred through more than 90° from a working position into a transport position, the movable or swinging components or assemblies remain unsecured in their then corresponding end position, such that these can continue to move in an uncontrolled and undefined manner during transport, or during travel on the road, or during the transition from fields and/or dirt roads. These uncontrolled movements of the intake auger parts relative to the corresponding machine parts are not only unpleasant for the driver, they can also cause damage to the corresponding suspension points and to further machine components.

According to the invention, therefore, the swinging intake auger, at least the intake auger parts that are seated or suspended on the foldable machine frame parts, are fixed, in particular blocked or locked, in an end position, and are thus secured prior to the folding of the corresponding machine frame part from the working position into the transport position. This is carried out as necessary, i.e., in particular prior to transferring the foldable machine frame parts into the transport position. Preferably, the corresponding intake auger parts are fixed, in particular blocked or locked, in the lower end position. Once the pick-up attachment according to the invention has been brought from its transport position into the working position, the fixation of the intake auger parts is released again. Reference is therefore made to a reversible fixation. The intake auger parts are therefore, in particular, unblocked or unlocked again. This enables the intake auger, when in the working position or in the harvesting mode, to swing freely again and optimally adapt to the flow of harvested crop.

It can be advantageous when the fixation and the release of the fixation is executable when the foldable pick-up attachment is in the working position, i.e., prior to the transfer from the working position into the transport position or after the transfer from the transport position into the working position.

It can be advantageous when the device for reversibly fixing the intake auger part has hydraulically actuatable means, preferably an extendable hydraulic cylinder, electrically actuatable means, preferably an extendable actuator or an attracting magnet, and/or mechanically actuatable means, preferably a lever or a spring plunger.

It can be advantageous when the intake auger part is reversibly fixable at one or more than one point relative to or on the machine frame part.

It can be advantageous when the intake auger part is reversibly fixable relative to or on one adjacent intake auger part and, thus, relative to or on the machine frame part.

It can be advantageous when the intake auger parts are each arranged between two intake auger arms, or intake auger holders, wherein the intake auger arms, or the intake auger holders, each have an elongated hole, which specifies the swing travel of the intake auger, wherein two adjacent intake auger arms, or intake auger holders, have the elongated hole at the same level and form a folding point when these adjacent intake auger arms, or intake auger holders, are foldable apart and foldable together, wherein the device for fixing the intake auger part relative to or on the folding machine frame part has a spring plunger, which is arranged on the folding machine frame part such that, when the pick-up attachment is transferred from the working position into the transport position, the spring force presses the plunger into the elongated hole, which can then be considered to be a blocking bore, provided in the folding intake auger arm, or intake auger holder, as a result of which the intake auger part associated with this intake auger arm, or intake auger holder, is fixed immediately after the departure from the working position, and such that, when the pick-up attachment is transferred from the transport position into the working position, a pressure piece arranged on the adjacent, non-foldable machine frame part presses the spring plunger out of the elongated hole, or the blocking bore, shortly before the working position is reached, such that the intake auger can swing freely again in the working position.

It can be advantageous when the mechanism and/or the controller for fixing the intake auger part relative to or on the machine frame part is operatively connected to the folding mechanism and/or the controller of the folding mechanism.

It can be advantageous when the intake auger part in the working position is reversibly fixable, preferably in an upper end position, relative to or on the machine frame part in order to prevent the intake auger from swinging during necessary maintenance and/or repair work and to provide better access for such work.

It can be advantageous when the fixation of the intake auger part relative to or on the machine frame part in the working position in order to prevent the intake auger from swinging or to establish better access for maintenance and/or repair work is activatable from a secured service menu.

The invention also relates to an improved method in conjunction with the folding apart and folding together of a pick-up attachment for a harvesting machine, preferably for a forage harvester, particularly preferably for a self-propelled forage harvester, which comprises a pick-up rotor with pick-up tools for picking up crop from the ground and an intake auger for uniformly handing off the picked-up crop to the harvesting machine, wherein the pick-up attachment has a machine frame, which is folded apart into a working position and folded together into a transport position using a folding mechanism, wherein the machine frame has a folding machine frame part. According to the invention, the intake auger is suspended on the machine frame in a swinging manner such that this can be adapted to different layer thicknesses of the crop by lifting and lowering, and/or at least that part of the intake auger that is suspended on the folding machine frame part is reversibly fixed, in particular reversibly blocked or reversibly locked, as necessary, relative to this or on this machine frame part by means of a device.

It can be advantageous when the fixation and the release of the fixation is carried out in the working position of the foldable pick-up attachment, i.e., prior to the transfer from the working position into the transport position or after the transfer from the transport position into the working position.

It can be advantageous when the fixation is carried out hydraulically, electrically, and/or mechanically.

It can be advantageous when the intake auger part is reversibly fixed at one or more than one point relative to or on the machine frame part.

It can be advantageous when the intake auger part is reversibly fixed relative to an adjacent intake auger part and, thus, relative to or on the machine frame part.

It can be advantageous when the intake auger parts are each arranged between two intake auger arms, or intake auger holders, wherein the intake auger arms, or the intake auger holders, each have an elongated hole, which specifies the swing travel of the intake auger, wherein two adjacent intake auger arms, or intake auger holders, have the elongated hole at the same level and form a folding point when these adjacent intake auger arms, or intake auger holders, are foldable apart and foldable together, wherein the device for fixing the intake auger part relative to or on the folding machine frame part has a spring plunger, which is arranged on the folding machine frame part such that, when the pick-up attachment is transferred from the working position into the transport position, the spring force presses the plunger into the elongated hole, which is quasi a blocking bore, provided in the folding intake auger arm, or intake auger holder, as a result of which the intake auger part associated with this intake auger arm, or intake auger holder, is fixed immediately after the departure from the working position, and such that, when the pick-up attachment is transferred from the transport position into the working position, a pressure piece arranged on the adjacent, non-foldable machine frame part presses the spring plunger out of the blocking bore shortly before the working position is reached, such that the intake auger can swing freely again in the working position.

It can be advantageous when the mechanism and/or the controller for fixing the intake auger part relative to or on the machine frame part is operatively connected to the folding mechanism and/or the controller of the folding mechanism.

It can be advantageous when the intake auger part is reversibly fixed, in particular blocked or locked, immediately prior to the onset of movement of the folding machine frame part at the latest and, at the earliest, after the intake auger part has come to a standstill.

It can be advantageous when the intake auger part is fixed, in particular blocked or locked, shortly before or simultaneously with the unlocking of the machine frame parts.

It can be advantageous when the fixation of the intake auger part is released, in particular the intake auger part is unblocked or unlocked, immediately prior to the start, or the start-up, of the pick-up attachment at the latest and, at the earliest, directly after the folding machine frame part has reached its end position in the working position.

It can be advantageous when the fixation of the intake auger part is released, in particular the intake auger part is unblocked or unlocked, shortly after or simultaneously with the unlocking of the machine frame parts in the working position.

It can be advantageous when, together with the intake auger parts, further machine components, in particular a hold-down unit, which are suspended on the respective machine frame parts in a movable or swinging manner, are also fixed, in particular blocked or locked, or the fixations are released, in particular unblocked or unlocked.

It can be advantageous when the fixation, in particular the blocking or locking, or the release of the fixation, in particular the unblocking or unlocking, of the machine components suspended on a machine frame part in a movable or swinging manner are operatively connected.

Given all of the above, the following advantages of a foldable pick-up attachment according to the invention for a harvesting machine, in particular for a forage harvester, in comparison with the prior art are as follows:
increased harvesting capacity due to an enlargement of the working width
increased productivity and reduced set-up times of a wide pick-up attachment due to the fact that this is designed to be foldable
improved flow of harvested crop and, as a result, improved feed quality as well as improved productivity and fuel efficiency due to the fact that the intake auger of a foldable pick-up attachment is suspended in a swinging manner
improved ease of maintenance and accessibility for a foldable pick-up attachment mounted on the harvesting machine, in particular on the forage harvester, due to the fact that the swing travel of the intake auger can be designed to be so great that the intake auger, when in its upper end position, is sufficiently far away from the base of the machine frame of the pick-up attachment, as a result of which it is made considerably easier for the driver to clean and/or clear out the pick-up attachment after an emergency stop or any other type of irregularity in the flow of harvested crop

Further features of the invention can be gathered from the claims, the figures, and the description of the figures. All features and combinations of features mentioned above in the description, as well as the features and combinations of features mentioned in the following in the description of the figures and/or shown individually in the figures, are usable not only in the particular combination indicated, but also in other combinations or alone.

The invention is now explained in greater detail on the basis of preferred exemplary embodiments and with reference to the attached drawings. Wherein:

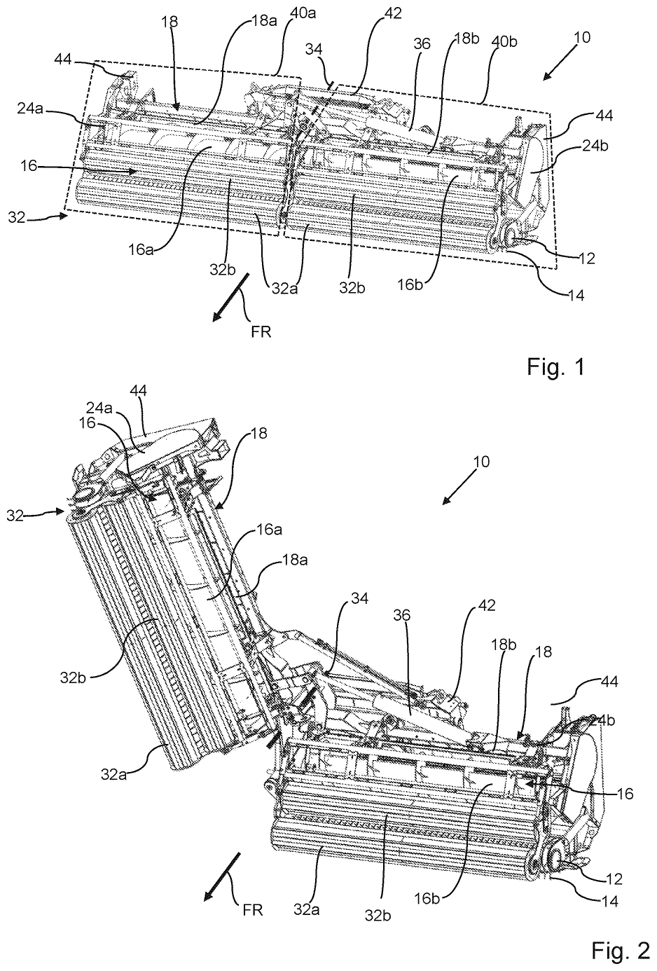

FIG. 1 shows a perspective view of a foldable pick-up attachment from the front in the working position,

FIG. 2 shows a perspective view of the foldable pick-up attachment shown in FIG. 1 from the front during the initial phase of the folding process from the working position into the transport position,

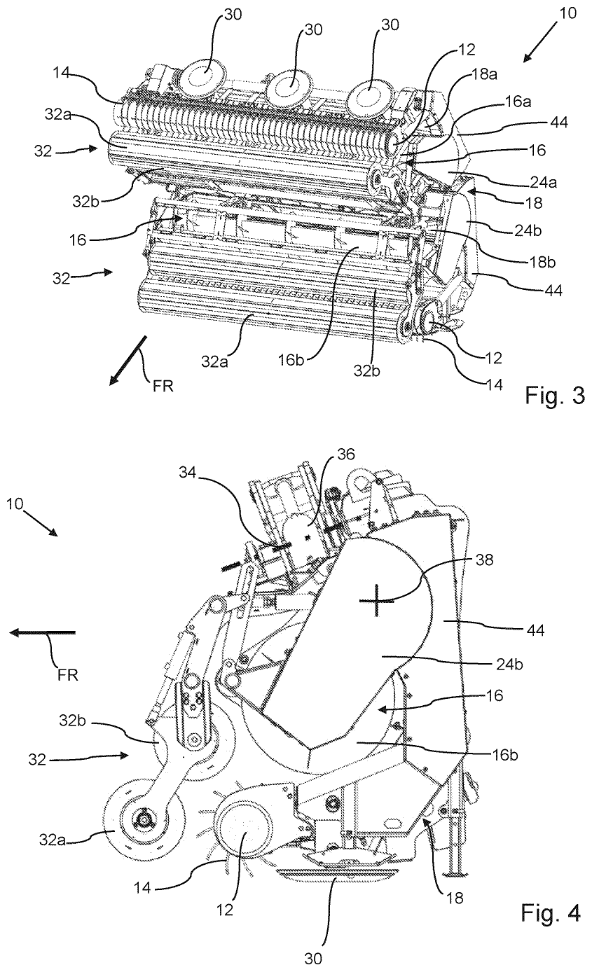

FIG. 3 shows a perspective view of the foldable pick-up attachment shown in FIG. 1 from the front in the transport position at the end of the folding process,

FIG. 4 shows a side view of the foldable pick-up attachment shown in FIG. 1 in the working position with an intake auger in the lower end position,

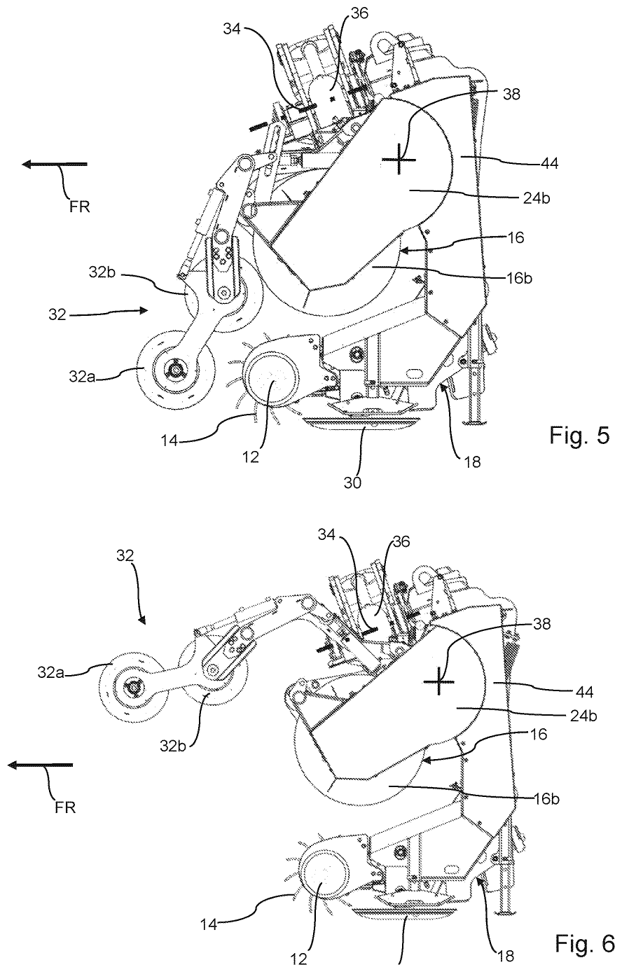

FIG. 5 shows a side view of the foldable pick-up attachment shown in FIG. 1 in the working position with an intake auger in the slightly lifted, or raised, state,

FIG. 6 shows a side view of the foldable pick-up attachment shown in FIG. 1 in the working position with an intake auger in the upper end position,

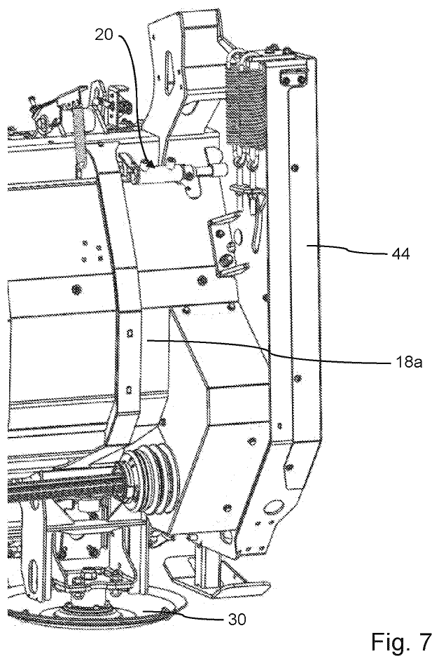

FIG. 7 shows a perspective view of a device in the form of a hydraulic cylinder for reversibly fixing an intake auger part on a machine frame part;

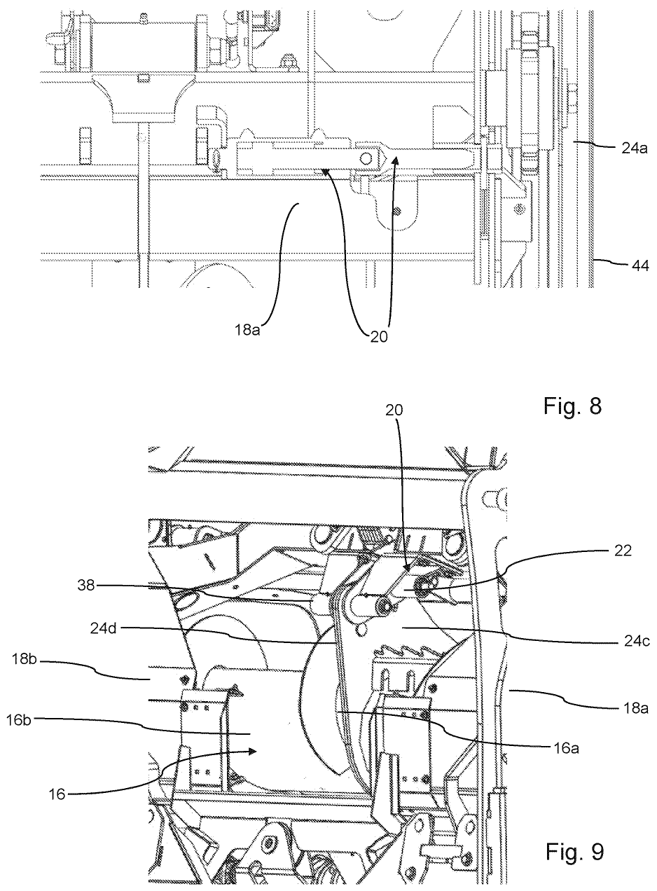

FIG. 8 shows a detailed view of the device shown in FIG. 7,

FIG. 9 shows a perspective view of a device in the form of a spring plunger for reversibly fixing an intake auger part to a machine frame part in a working position of the pick-up attachment,

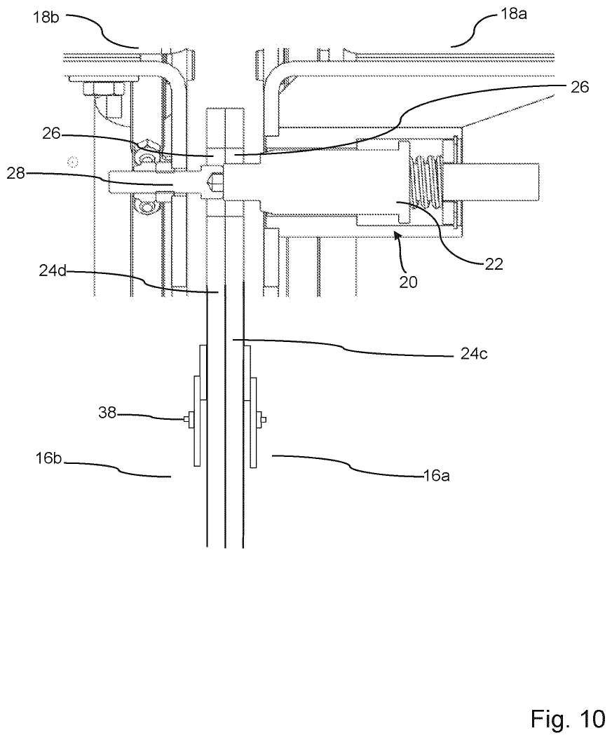

FIG. 10 shows a detailed view of the device shown in FIG. 9,

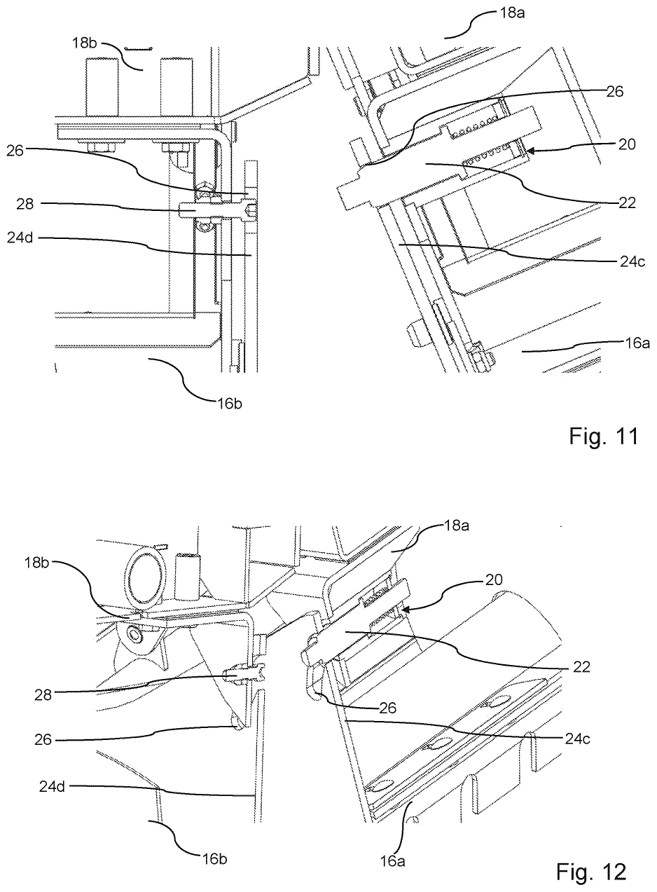

FIG. 11 shows a perspective view of the device according to FIG. 9 shortly after the departure from the working position of the pick-up attachment, and

FIG. 12 shows a detailed view of the device shown in FIG. 11.

If the same reference numerals are used in FIG. 1 through 12, these also designate the same parts or regions.

FIG. 1 through 3 each show a perspective view of a foldable pick-up attachment 10 from the front, i.e., counter to the direction of travel FR, in the working position (FIG. 1), during the initial phase of the folding process from the working position into the transport position (FIG. 2), and in the transport position at the end of the folding process (FIG. 3).

The foldable pick-up attachment 10 for a self-propelled forage harvester, which is not shown here, comprises a machine frame 18 with two machine frame parts 18a, 18b, namely a left and a right machine frame part 18a, 18b, each of which supports a machine half and which are foldable apart and foldable together using a folding mechanism. The right machine half 40a and the left machine half 40b are characterized in FIG. 1 using dashed framings.

Each machine frame part 18a, 18b comprises a pick-up rotor 12 with pick-up tools 14, which are designed as rake tines in the present case, for picking up crop from the ground, wherein each pick-up rotor 12 is connected to three guide elements 30 lying on the ground, or the underlying surface, which are designed as sliding plates in the present case. The guide elements 30 take on the guidance of the pick-up rotor 12 and guide this towards the ground. The ground is usually the topsoil. Moreover, each machine half, or each machine frame part 18a, 18b, has an intake auger 16 transferring the picked-up crop as a crop mat, which can also be referred to as a cross auger, consisting of two intake auger parts 16a, 16b. Moreover, each machine half, or each machine frame part, comprises a hold-down unit 32, preferably in the form of a front hold-down element 32a designed as a roller and a rear hold-down element 32b designed as a roller, which specify the direction of the flow of harvested crop when the crop is conveyed upwards with great acceleration on account of the rotating pick-up tools 14. The pick-up rotor 12 and the hold-down unit 32 are suspended on the machine frame preferably in a swinging manner.

The pick-up attachment 10 also comprises a sliding frame 42, which, in order to operate concurrently with the folding mechanism, is arranged on the side of the machine frame 18 facing rearward in the direction of travel FR and is connected thereto. When the presently two-part foldable pick-up attachment 10 is in the working position, i.e., with the machine halves 40a, 40b, or the machine frame parts 18a, 18b, folded apart, the folding axis 34 is in the machine center, or in the center of the machine frame 18, in the direction of travel FR. As shown in FIG. 1 through 3 in different phases, for changing between the working position and the transport position, the machine half 40a on the right in the direction of travel FR, or the right machine frame part 18a, is folded onto the left machine half 40b, or onto the left machine frame part 18b. For uniformly introducing load into the pre-compression housing of the forage harvester, the folded pick-up attachment 10 must be symmetrically arranged ahead of the pre-compression housing of the forage harvester also in the transport position. In order to ensure that the pick-up attachment 10 is symmetrically arranged ahead of the pre-compression housing of the forage harvester in the transport position and in the working position, the machine frame 18 is correspondingly moved in the sliding frame 42 during the folding process. To achieve this, the sliding frame 42 accommodates the two machine halves 40a, 40b, or the machine frame parts 18a, 18b, at its end in the front in the direction of travel FR. The two machine halves 40a, 40b, or machine frame parts 18a, 18b, are rotatably coupled to one another via the axis of rotation, or the folding axis 34. A folding cylinder 36, which is arranged between the two machine halves, or machine frame parts 18a, 18b, swivels the folding machine half 40a, or the folding machine frame part 18a, through 180° toward the sliding machine half 40b, or the sliding machine frame part 18b. The sliding machine half 40b, or the sliding machine frame part 18b, is slidably guided in the sliding frame 42.

According to the invention, the intake auger 16 is suspended on the machine frame 18 in a swinging manner such that this 16 is adaptable to different layer thicknesses of the crop by lifting and lowering.

In FIG. 4 through 6, different positions of the intake auger 16 during the swinging are shown. In FIG. 4, the intake auger 16 is in a lower end position. The intake auger 16 is lowered. This is a position when the pick-up attachment 10 in the working position. In FIG. 5, the intake auger 16 is in a slightly lifted, or raised, state. The intake auger 16 has deflected upwards about a pivot point 38. This is the case, for example, when the layer thickness of the crop map increases. This is also a position of the intake auger 16 when the pick-up attachment 10 is in the working position. In FIG. 6, the intake auger 16 is in an upper end position. The intake auger 16 has deflected upwards about the pivot point 38 to an upper end position. In this upper end position of the intake auger 16, the pick-up attachment 10 is particularly easily accessible toward the inside, or toward the intake conveyor mechanisms of the harvesting machine, in particular of the forage harvester, for cleaning and maintenance work.

FIG. 4 through 6 also very clearly illustrate, however, one possible disadvantage of a swinging suspension of the intake auger 16 on the foldable machine frame 18 of the foldable pick-up attachment 10. The intake auger parts 16a suspended in a movable or swinging manner relative to the folding machine frame parts 18a inadvertently drop from the one end position into the other end position namely when the machine frame parts 18a are transferred from a working position into a transport position, or vice versa.

In order to avoid such an inadvertent back-and-forth movement, or drop, according to the invention, at least one device 20 is provided, by means of which at least that part of the intake auger 16a that is suspended on the folding machine frame part 18a is reversibly fixable, as necessary, relative to this or on this machine frame part 18a. In addition, that part of the intake auger 16b that is suspended on the non-folding machine frame part 18b can also is reversibly fixable relative to this or on this machine frame part 18b. The fixation of the non-folding intake auger part 16b with respect to or on the non-folding machine frame part 18b has the advantage, as is also the case for the fixation of the folding intake auger part 16b relative to or on the folding machine frame part 18b, that the intake auger 16 can be secured in an upper end position when the pick-up attachment 10 is in the working position, in particular in a position in which the pick-up attachment 10 is particularly easily accessible toward the inside, or toward the intake conveyor mechanisms of the harvesting machine, in particular of the forage harvester, for cleaning and maintenance work.

FIGS. 7 and 8 show a device 20 for reversibly fixing an intake auger part 16a on a machine frame part 18a in the form of a hydraulic cylinder. The intake auger 16 is arranged on a movable intake auger arm 24a, or between two movable intake auger arms 24a, 24b, or intake auger holders 24c, 24d. The hydraulic cylinder is arranged between an intake auger arm 24a and an outer side part 44 of the machine frame 18. Extending the hydraulic cylinder prevents the intake auger arm 24a from moving relative to the machine frame part 18a, or its outer side part 44.

FIG. 9 through 12 show a device in the form of a spring plunger for reversibly fixing an intake auger part 14a on a machine frame part 18a.

As described above, the intake auger parts 16a, 16b can each be arranged between two intake auger arms 24a, 24b, or intake auger holders 24c, 24d. The intake auger arms 24a, 24b, or intake auger holders 24c, 24d, each have an elongated hole 26, which specifies the swing travel of the intake auger 16. Two adjacent intake auger arms 24a, 24b, or intake auger holders 24c, 24d, have the elongated hole 26 at the same level and form a folding point when these adjacent intake auger arms 24a, 24b, or intake auger holders 24c, 24d, are foldable apart and foldable together, wherein the device 20 for fixing the intake auger part 16a relative to or on the folding machine frame part 18a has a spring plunger 22, which is arranged on the folding machine frame part 18a such that, when the pick-up attachment 10 is transferred from the working position into the transport position, the spring force presses the plunger into the elongated hole 26 provided in the folding intake auger holder 24c, which is a blocking bore, as a result of which the intake auger part 16a associated with this intake auger holder 24c is fixed immediately after the departure from the working position, and such that, when the pick-up attachment 10 is transferred from the transport position into the working position, a pressure piece 28 arranged on the adjacent, non-foldable machine frame part 18b presses the spring plunger 22 out of the blocking bore shortly before the working position is reached, such that the intake auger 16a can swing freely again in the working position.

### LIST OF REFERENCE NUMERALS

10 pick-up attachment
12 pick-up rotor
14 pick-up tools
16 intake auger
16a intake auger part
16b intake auger part
18 machine frame
18a machine frame part
18b machine frame part
20 device
22 spring plunger
24a intake auger arm
24b intake auger arm
24c intake auger holder
24d intake auger holder
26 elongated hole
28 pressure piece
30 guide element
32 hold-down unit
32a front hold-down element
32b rear hold-down element
34 folding axis
36 folding cylinder
38 pivot point/axis of rotation
40a right machine half
40b left machine half
42 sliding frame
44 side part
FR direction of travel

1: A foldable pick-up attachment (10) for a harvesting machine, preferably for a forage harvester, particularly preferably for a self-propelled forage harvester, comprising a pick-up rotor (12) with pick-up tools (14) for picking up crop from the ground and an intake auger (16) for uniformly handing off the picked-up crop to the harvesting machine, wherein the pick-up attachment (10) has a machine frame (18), which is foldable apart into a working position and foldable together into a transport position using a folding mechanism, wherein the machine frame (18) has a folding machine frame part (18a), wherein the intake auger (16) is suspended on the machine frame (18) in a swinging manner such that the intake auger (16) is adaptable to different layer thicknesses of the crop by lifting and lowering, and/or such that at least one device (20) is provided, by means of which at least that part of the intake auger (16a) that is suspended on the folding machine frame part (18a) is reversibly fixable, as necessary, relative to this folding machine frame part (18a) or on this folding machine frame part (18a).

2: The foldable pick-up attachment (10) of claim 1, wherein the fixation and the release of the fixation is executable when the foldable pick-up attachment (10) is in the working position, i.e., prior to the transfer from the working position into the transport position or after the transfer from the transport position into the working position.

3: The foldable pick-up attachment (10) of claim 1, wherein the device (20) for reversibly fixing the intake auger part (16a) has hydraulically actuatable means, preferably an extendable hydraulic cylinder, electrically actuatable means, preferably an extendable actuator or an attracting magnet, and/or mechanically actuatable means, preferably a lever or a spring plunger (22).

4: The foldable pick-up attachment (10) of claim 1, wherein the intake auger part (16a) is reversibly fixable at one point or at more than one point relative to the machine frame part (18a).

5: The foldable pick-up attachment (10) of claim 1, wherein the intake auger part (16a) is reversibly fixable relative to one adjacent intake auger part (16b) or on one adjacent intake auger part (16b) and, thus, relative to or on the machine frame part (18a).

6: The foldable pick-up attachment (10) of claim 1, wherein the intake auger parts (16a, 16b) are each arranged between two intake auger arms (24a, 24b), or intake auger holders (24c, 24d), wherein the intake auger arms (24a, 24b), or the intake auger holders (24c, 24d), each have an elongated hole (26), which specifies the swing travel of the intake auger (16), wherein two adjacent intake auger arms (24a, 24b), or intake auger holders (24c, 24d), have the elongated hole (26) at the same level and form a folding point when these adjacent intake auger arms (24a, 24b), or intake auger holders (24c, 24d), are foldable apart and foldable together, wherein the device (20) for fixing the intake auger part (16a) relative to or on the folding machine frame part (18a) has a spring plunger (22), which is arranged on the folding machine frame part (18a) such that, when the pick-up attachment (10) is transferred from the working position into the transport position, the spring force presses the plunger into the elongated hole (26), which is a blocking bore, provided in the folding intake auger arm, or intake auger holder (24c), as a result of which the intake auger part (16a) associated with this intake auger arm, or intake auger holder (24c), is fixed immediately after the departure from the working position, and such that, when the pick-up attachment (10) is transferred from the transport position into the working position, a pressure piece (28) arranged on the adjacent, non-foldable machine frame part (18b) presses the spring plunger (22) out of the blocking bore shortly before the working position is reached, such that the intake auger (16a) can swing freely again in the working position.

7: The foldable pick-up attachment (10) of claim 1, wherein the mechanism and/or the controller for fixing the intake auger part (16a) relative to or on the machine frame part (18a) is operatively connected to the folding mechanism and/or the controller of the folding mechanism.

8: The foldable pick-up attachment (10) of claim 1, wherein the intake auger part (16a) in the working position is reversibly fixable relative to or on the machine frame part (18a) in order to prevent the intake auger (16) from swinging during necessary maintenance and/or repair work.

9: The foldable pick-up attachment (10) of claim 8, wherein the fixation of the intake auger part (16a) relative to or on the machine frame part (18a) in the working position in order to prevent the intake auger (16a) from swinging is activatable from a secured service menu.

10: A method for folding apart and together a pick-up attachment for a harvesting machine, preferably for a forage harvester, particularly preferably for a self-propelled forage harvester, which comprises a pick-up rotor with pick-up tools for picking up crop from the ground and an intake auger for uniformly handing off the picked-up crop to the harvesting machine, wherein the pick-up attachment has a machine frame, which is folded apart into a working position and folded together into a transport position using a folding mechanism, wherein the machine frame has a folding machine frame part, wherein the intake auger is suspended on the machine frame in a swinging manner such that the intake auger is adapted to different layer thicknesses of the crop by lifting and lowering, and/or such that at least that part of the intake auger that is suspended on the folding machine frame part is reversibly fixed, in particular reversibly blocked or reversibly locked, as necessary, relative to or on this machine frame part by means of a device.

11: The method of claim 10, wherein the fixation and the release of the fixation is carried out when the foldable pick-up attachment is in the working position, i.e., prior to the transfer from the working position into the transport position or after the transfer from the transport position into the working position.

12: The method of claim 1, wherein the fixation is carried out hydraulically, electrically, and/or mechanically.

13: The method of claim 1, wherein the intake auger part is reversibly fixed at one point or at more than one point relative to or on the machine frame part.

14: The method of claim 1, wherein the intake auger part is reversibly fixed relative to an adjacent intake auger part and, thus, relative to the machine frame part.

15: The method of claim 1, wherein the intake auger parts are each arranged between two intake auger arms and/or intake auger holders, wherein the intake auger arms and/or the intake auger holders each have an elongated hole, which specifies the swing travel of the intake auger, wherein two adjacent intake auger arms and/or intake auger holders have the elongated hole at the same level and form a folding point when these adjacent intake auger arms and/or intake auger holders are foldable apart and foldable together, wherein the device for fixing the intake auger part relative to or on the folding machine frame part has a spring plunger, which is arranged on the folding machine frame part such that, when the pick-up attachment is transferred from the working position into the transport position, the spring force presses the plunger into the elongated hole, which is a blocking bore, provided in the folding intake auger arm and/or intake auger holder, as a result of which the intake auger associated with this intake auger arm and/or intake auger holder is fixed immediately after the departure from the working position, and such that, when the pick-up attachment is transferred from the transport position into the working position, a pressure piece arranged on the adjacent, non-foldable machine frame part presses the spring plunger out of the blocking bore shortly before the working position is reached, such that the intake auger can swing freely again in the working position.

16: The method of claim 1, wherein the mechanism and/or the controller for fixing the intake auger part relative to or on the machine frame part is operatively connected to the folding mechanism and/or the controller of the folding mechanism.

17: The method of claim 1, wherein the intake auger part is reversibly fixed, in particular blocked or locked, immediately prior to the onset of movement of the folding machine frame part at the latest and, at the earliest, after the intake auger part has come to a standstill.

18: The method of claim 1, wherein the intake auger part is fixed, in particular blocked or locked, shortly before or simultaneously with the unlocking of the machine frame parts.

19: The method of claim 1, wherein the fixation of the intake auger part is released, in particular the intake auger part is unblocked or unlocked, immediately prior to the start, or the start-up, of the pick-up attachment at the latest and, at the earliest, directly after the folding machine frame part has reached its end position in the working position.

20: The method of claim 1, wherein the fixation of the intake auger part is released shortly after or simultaneously with the locking of the machine frame parts in the working position, in particular the intake auger part is unblocked or unlocked.

21: The method of claim 1, wherein, together with the intake auger parts, further machine components, in particular a hold-down unit, which are suspended on the respective machine frame parts in a movable or swinging manner, are also fixed, in particular blocked or locked, or the fixations are released, in particular unblocked or unlocked.

22: The method of claim 1, wherein the fixation, in particular the blocking or locking, or the release of the fixation, in particular the unblocking or unlocking, of the machine components suspended on a machine frame part in a movable or swinging manner are operatively connected.
